(19) United States
(12) Patent Application Publication
(10) Pub. No.: US 2005/0131320 A1
(43) Pub. Date: Jun. 16, 2005

(54) Massaging apparatus

(76) Inventor: Chin-Tsun Lee, Yongkang City (TW)

Correspondence Address: CHIN-TSUN LEE, P.O. Box 90, Tainan City, 704, TW

(21) Appl. No.: 10/732,407

(22) Filed: Dec. 11, 2003

(51) Int. Cl. A61H 15/00; A61H 39/04

(52) U.S. Cl. 601/119; 601/120; 601/135

(57) ABSTRACT

A massaging apparatus has a handle or a massaging base provided with a massaging knob on the opposite ends. In using, simply hold the handle or the massaging base, or step on the massaging knobs of the massaging base to have the massaging knobs contacting closely with a person's acupuncture points, and then swing the handle slightly and press it downward to perform massaging on the acupuncture points, having excellent effect of massaging.

### BACKGROUND OF THE INVENTION

1. Field of the Invention

This invention relates to a massaging apparatus, particularly to one having a handle or a massaging base provided with a massaging knob at the opposite ends. In using, simply hold the handle or the massaging base, or step on the massaging knobs of the massaging base to make the massaging knobs contact closely with a person's acupuncture points to be massaged and then swung slightly and pressed deeply on the acupuncture points, having excellent effect of massaging.

2. Description of the Prior Art

A conventional massaging apparatus 1, as shown in FIG. 1, includes two position bases 10 having two shafts 11 provided therebetween. Each shaft 11 is fitted thereon with a plurality of rolling posts 12 respectively formed thereon with numerous horizontal and vertical recesses 13 spaced apart equidistantly. In using, the conventional massaging apparatus 1 is held to contact closely with a certain portion of a person's body to be massaged, such as shoulder, neck, ridge, back, hand, leg and the like, and then pressed downward and moved reciprocally to let the rolling posts 12 with uneven surfaces rotate on the shaft 11 and perform massaging on a person's body.

However, the rolling posts 12 of the conventional apparatus 1 are shaped straight so they can hardly match with the curved portions of a person's body. In other words, the conventional massaging apparatus 1 can only contact with limited portions of a person's body for massaging, but cannot deeply be pressed on a man's acupuncture points to carry out massaging.

### SUMMARY OF THE INVENTION

The objective of the invention is to offer a massaging apparatus able to have its massaging knobs pressed deeply on a person's acupuncture points to perform massaging, having effects of elimination of soreness and pain as well as promotion of blood circulation.

A first feature of the invention is a handle having its opposite ends provided with at least one massaging knob.

A second feature of the invention is a massaging base having its opposite ends provided with at least one massaging knob.

### BRIEF DESCRIPTION OF DRAWINGS

This invention will be better understood by referring to the accompanying drawings, wherein:

FIG. 1 is a perspective view of a conventional massaging apparatus;

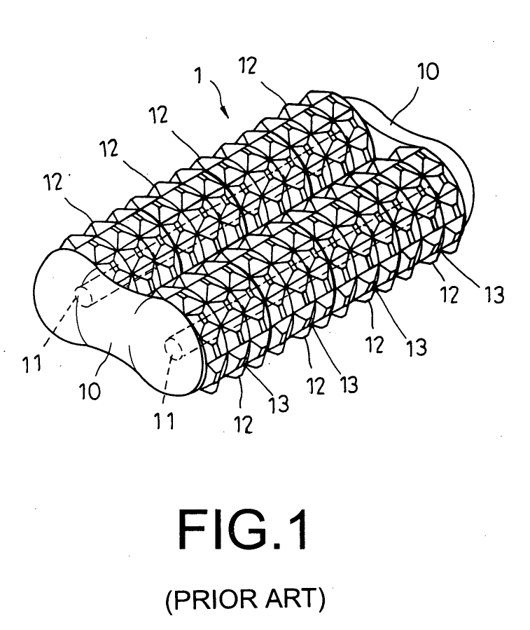

FIG. 2 is a perspective view of a first preferred embodiment of the handle of a massaging apparatus in the present invention;

FIG. 3 is a perspective view of the first preferred embodiment of the massaging apparatus in the present invention;

FIG. 4 is a perspective view of the first preferred embodiment of the massaging apparatus having the massaging knob on its handle pressed on a man's shoulder or neck for massaging in the present invention;

FIG. 5 is a perspective view of the first preferred embodiment of the massaging apparatus rolled to perform massaging on a man's leg or abdomen in the present invention;

FIG. 6 is a perspective view of a second preferred embodiment of the massaging base of a massaging apparatus in the present invention;

FIG. 7 is a perspective view of the second preferred embodiment of the massaging apparatus in the present invention;

FIG. 8 is a perspective view of the second preferred embodiment of the massaging apparatus in a used condition in the present invention; and,

FIG. 9 is a perspective view of the second preferred embodiment of the massaging apparatus in another used condition in the present invention.

### DETAILED DESCRIPTION OF THE PREFERRED EMBODIMENT

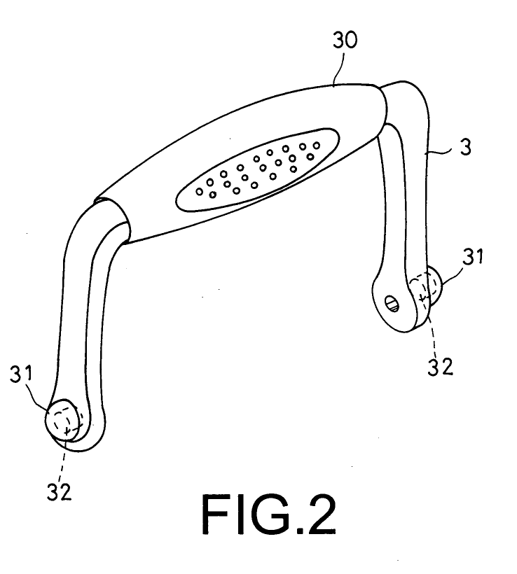

A first preferred embodiment of a massaging apparatus in the present invention, as shown in FIG. 2, includes a handle 3 and a massaging body 2 combined together.

The handle 3 is shaped an inverted U and has its upper portion formed with a holding member 30 and the outer sides of its opposite ends respectively provided with a massaging knob 31 having magnet 32 imbedded inside.

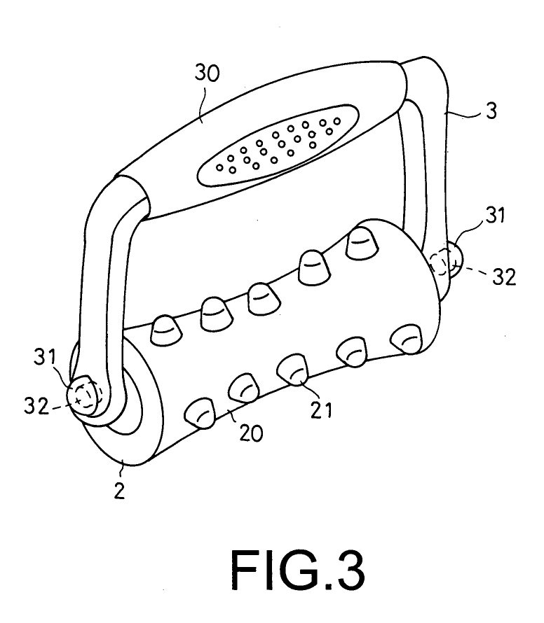

The massaging body 2 has its opposite ends pivotally assembled with the opposite ends of the handle 2, as shown in FIG. 3, and has its outer circumferential side formed with an recessed curve surface 20 provided thereon with numerous massaging knobs 21 respectively having an arc-shaped top.

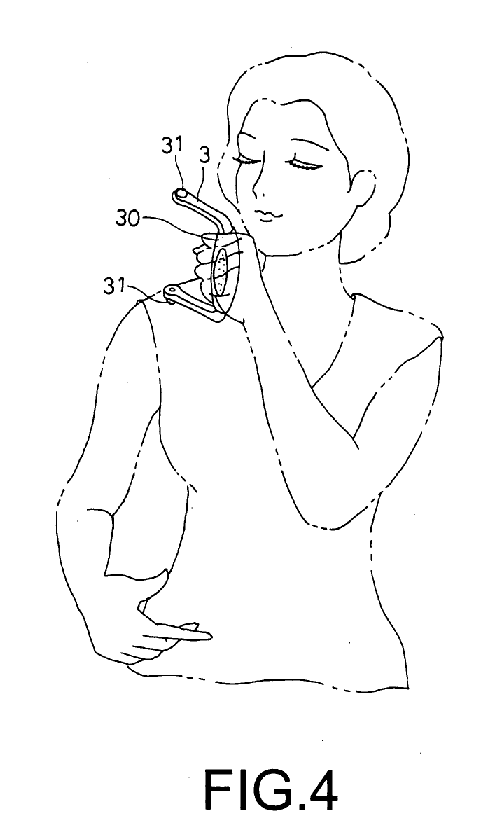

To carry out massaging on a man's acupuncture points, as shown in FIG. 4, only hold the holding member 30 of the handle 3 and erect the massaging body 2 to make the massaging knob 31 on the outer side of the handle 3 contact closely with the acupuncture point to be massaged. Then, press the handle 3 downward and swing it slightly to press the massaging knob 31 deeply on the man's acupuncture point and perform massaging. At this time, the magnet 32 embedded inside the massaging knob 31 will function to perform magnetic therapy to reinforce blood circulation during massaging. The massaging apparatus in the present invention is able to carry out massaging on sore and aching portions of a person's body according to a diagram of human body's acupuncture points, having effects of elimination of soreness and pain as well as promotion of blood circulation.

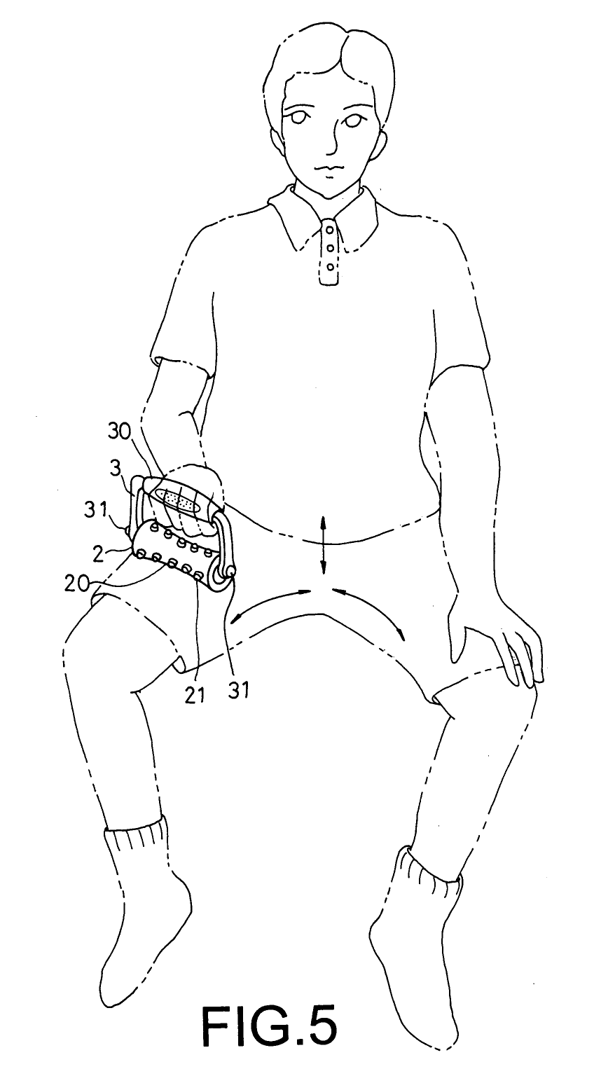

To carry out massaging on other portions of a man's body, as shown in FIG. 5, simply hold the holding member 30 of the handle 3 to press the massaging body 2 on certain portions of a man's body to be massaged, such as shoulder, neck, ridge, back, hand, leg, abdomen and the like. Then, roll the massaging body 2 reciprocally to have all the massaging knobs 21 on the massaging body 2 pressed and moved on a man's body to perform massaging thereon.

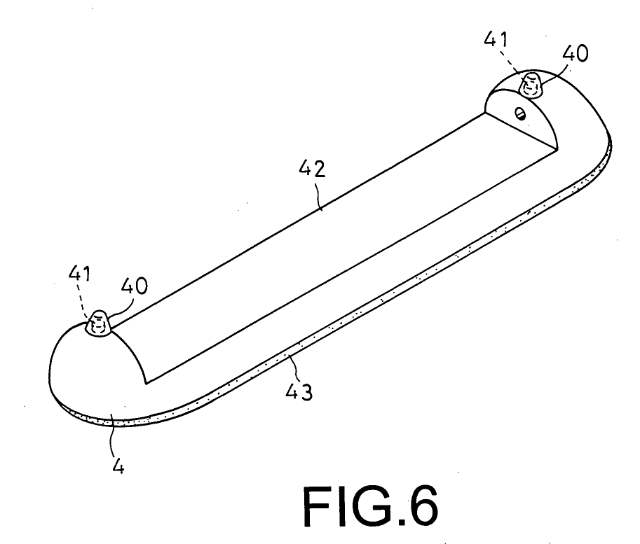

A second preferred embodiment of a massaging apparatus in the present invention, as shown in FIG. 6, includes a massaging base 4 and a massaging body 5 combined together.

The massaging base 4 has its opposite upper ends respectively provided with a massaging knob 40 having a magnet 41 embedded inside and its upper side formed with a lengthwise recess 42, having a slip-preventing member 43 provided under the massaging base 4.

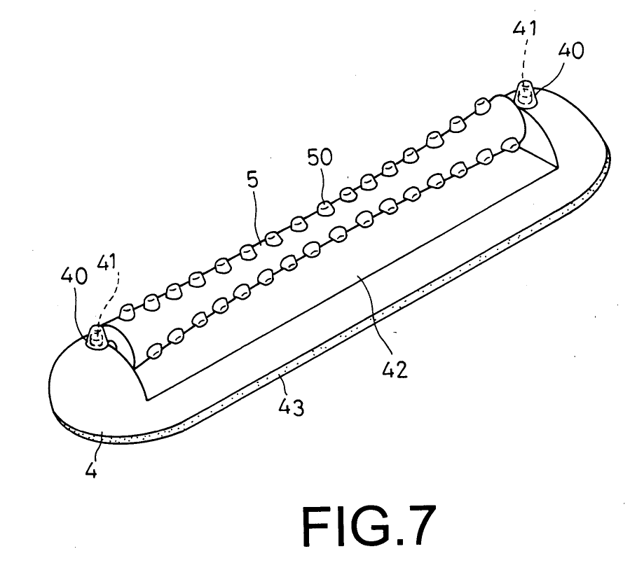

The massaging body 5 is rotatably fitted in the lengthwise recess 42 of the massaging base 4, having its outer surface provided with numerous massaging knobs 50, as shown in FIG. 7.

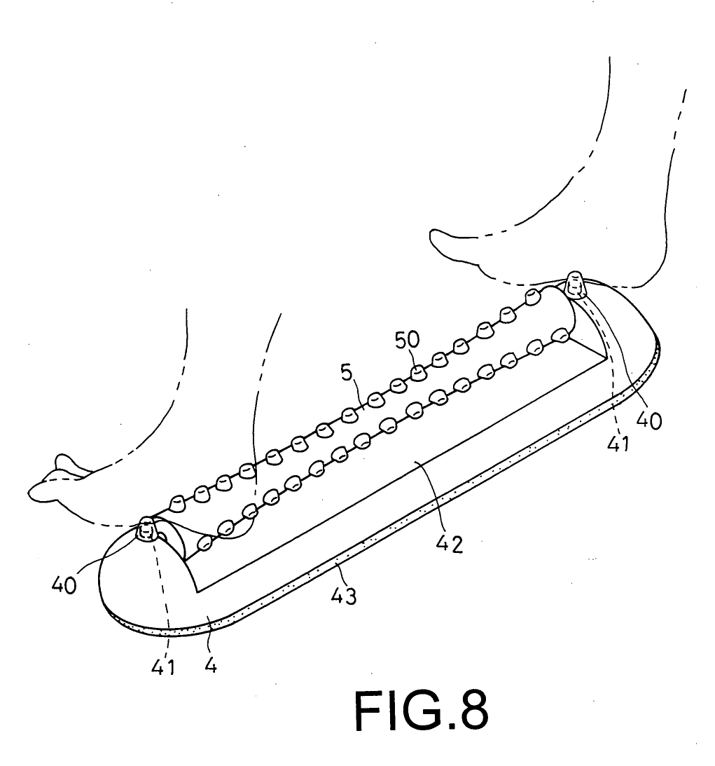

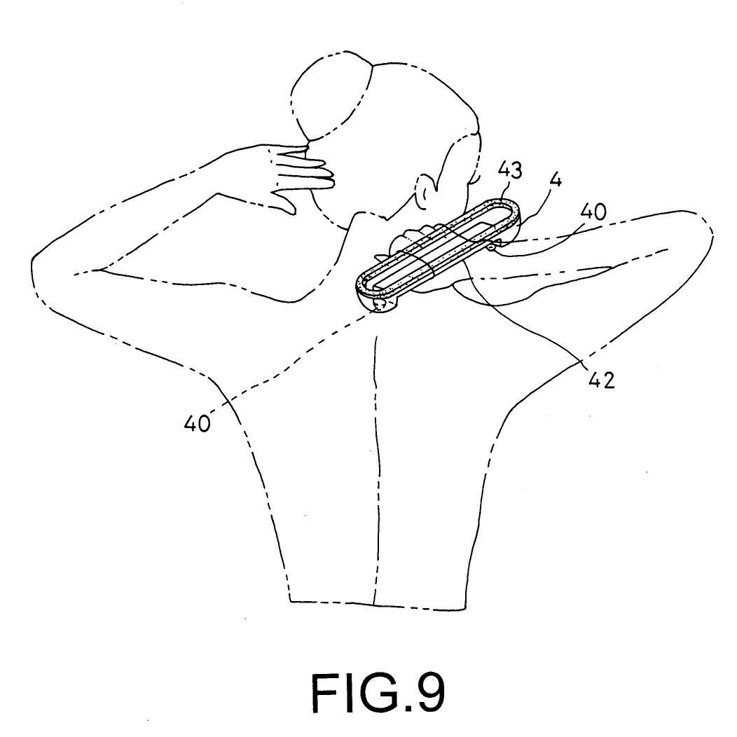

To carry out massaging on the acupuncture points of a person's soles, as shown in FIG. 8, only have the soles stepping on the massaging knobs 40 on the opposite ends of the massaging base 4 to have the massaging knobs 40 deeply pressing the acupuncture points to be massaged. Then, press the feet soles downward and swing them slightly, and synchronously the magnet 41 embedded in the massaging knob 40 will function to perform magnetic therapy so as to reinforce blood circulation during massaging. Such a massaging apparatus is able to carry out massaging on the acupuncture points of a person's soles in accordance with a diagram of the acupuncture points of a person's soles, having effects of elimination of soreness and aching as well as promotion of blood circulation. In addition, the massaging base 4 can also be held to press the massaging knobs 40 on any other acupuncture points of a person's body, such as shoulder, neck, back and the like, and carry out massaging thereon, as shown in FIG. 9.

While the preferred embodiments of the invention have been described above, it will be recognized and understood that various modifications may be made therein and the appended claims are intended to cover all such modifications that may fall within the spirit and scope of the invention.

1. A massaging apparatus comprising a handle, said handle having its opposite outer ends provided with a least one massaging knob, said handle held and said massaging apparatus erected to let said massaging knob contact closely with a man's acupuncture point to be massaged, said massaging knob pressed downward and swung slightly to perform massaging on the acupuncture point.

2. The massaging apparatus as claimed in claim 1, wherein said massaging knob has a magnet embedded inside to perform magnetic therapy.

3. The massaging apparatus as claimed in claim 1, wherein a massaging body is rotatably fitted between the opposite ends of said handle to be rolled to perform massaging.

4. A massaging apparatus comprising a massaging base, said massaging base having its opposite ends provided with at least one massaging knob, said massaging base held to have said massaging knob contacting closely with a man's acupuncture points to be massaged, said massaging knob pressed on said man's acupuncture points and swung slightly to carry out massaging thereon, person's soles stepping on said massaging knobs of said massaging base, the feet soles swung slightly to let said massaging knobs press deeply on said acupuncture points of the soles, having excellent effect of massaging.

5. The massaging apparatus as claimed in claim 4, wherein said massaging knob of said massaging base has a magnet embedded inside to perform magnetic therapy.

6. The massaging apparatus as claimed in claim 4, wherein a massaging body is rotatably fitted in the lengthwise recess of said massaging base to be rolled for massaging.

7. The massaging apparatus as claimed in claim 4, wherein a slip-preventing member is provided under said massaging base.
